(19) United States
(12) Patent Application Publication
(10) Pub. No.: US 2023/0068048 A1
(43) Pub. Date: Mar. 2, 2023

(54) RESIDENCE TIME DETERMINATION METHOD AND APPARATUS, EDGE COMPUTING DEVICE, AND STORAGE MEDIUM

(71) Applicant: SENSETIME INTERNATIONAL PTE. LTD., Singapore (SG)

(72) Inventors: Jiacheng WU, Singapore (SG); Dongliang SUN, Singapore (SG); Shuai ZHANG, Singapore (SG); Jinliang LIN, Singapore (SG); Xin GAN, Singapore (SG)

(21) Appl. No.: 17/489,034

(22) Filed: Sep. 29, 2021

Related U.S. Application Data
(63) Continuation of application No. PCT/IB2021/058440, filed on Sep. 16, 2021.

(30) Foreign Application Priority Data
Aug. 27, 2021 (SG) 10202109386W

(51) Int. Cl. A63F 13/79; A63F 13/213

(52) U.S. Cl. CPC A63F 13/79; A63F 13/213

(57) ABSTRACT

Provided are a residence time determination method and apparatus, an edge computing device, and a storage medium. The method includes that: a player image that is collected by an image collection apparatus and includes a specified part of a game player is acquired, and the image collection apparatus is deployed in a game area; identification information of the game player is determined on the basis of the feature information of the specified part in the player image; and the residence time of the game player in the game area is determined on the basis of the identification information of the game player and the existence time of the feature information of the game player in the game image.

### CROSS-REFERENCE TO RELATED APPLICATIONS

This is continuation of international application PCT/IB2021/058440 filed on 16 Sep. 2021, which claims priority to Singapore patent application No. 10202109386W filed with IPOS on 27 Aug. 2021. The contents of international application PCT/IB2021/058440 and Singaporean patent application No. 10202109386W are incorporated herein by reference in their entireties.

### TECHNICAL FIELD

The disclosure relates to the technology of computer vision processing, and relates, but not limited, to a residence time determination method and apparatus, an edge computing device and a storage medium.

### BACKGROUND

In a game place, whether a game player enters the game place or not can be basically determined through an image collection apparatus arranged at an entrance/exit of the game place. However, the residence time of the game player in any game area of the game place cannot be determined accurately.

### SUMMARY

A residence time determination method and apparatus, an edge computing device, and a storage medium provided by embodiments of the disclosure can accurately determine the residence time of a game player in a game area, so as to accurately determine the residence time of the game player in the game area.

The embodiments of the disclosure provide a residence time determination method. The method may include the following operations.

A player image that is collected by an image collection apparatus and includes a specified part of a game player is acquired. The image collection apparatus is deployed in a game area.

Identification information of the game player is determined on the basis of feature information of the specified part in the player image.

The residence time of the game player in the game area is determined on the basis of the identification information of the game player and the existence time of the feature information of the game player in the player image.

In specific embodiments, the operation that the identification information of the game player is determined on the basis of feature information of the specified part in the player image may include the following operations.

An identification information set including the identification information of at least one game player is acquired. The identification information set includes the feature information of the specified part of the at least one game player, and the identification information corresponding to the feature information of the specified part of the at least one game player.

The identification information is determined on the basis of the identification information set and the feature information of the specified part.

It may be understood that the identification information of the game player can be determined quickly and accurately by means of the feature information of the specified part in the game player and the feature information of the specified part in the identification information set.

In some embodiments, the operation that an identification information set including the identification information of at least one game player is acquired may include the following operations.

The identification information set is acquired from an edge computing device when the edge computing device stores the identification information set; and/or

the identification information set is acquired from a cloud device when the edge computing device does not store the identification information set.

It may be understood that the identification information set stored in the cloud device may be sent to the edge computing device according to a requirement of the edge computing device for determining the identification information, so as to realize secure backup and stable update of data of the identification information set, thereby providing guarantee for the determination of the identification information.

In some embodiments, the operation that the residence time of the game player in the game area is determined on the basis of the identification information of the game player and the existence time of the feature information of the game player in the player image may include the following operation.

The residence time of the game player, corresponding to the identification information, in the game area is determined on the basis of the existence time when the identification information of the game player is stored in a buffer storage space corresponding to the game area.

It may be understood that the residence time of the game player in the game area may be determined quickly and accurately by means of reading the data in the buffer storage space when the identification information of the game player is stored in the buffer storage space corresponding to the game area.

In some embodiments, the method may further include the following operations.

The player image is analyzed, and the identification information of the game player is stored in the buffer storage space corresponding to the game area when it is determined that the game player executes a specified operation.

It may be understood that the identification information of the game player is stored in the buffer storage space corresponding to the game area when it is determined that the game player executes the specified operation, so as to reduce the number of times of storing the identification information of the game player in the buffer storage space corresponding to the game area, and also reduce the amount of redundant data in the buffer storage space corresponding to the game area.

In some embodiments, the method may further include the following operations.

The storage duration of the identification information of the game player in the buffer storage space is acquired when the identification information of the game player is stored in the buffer storage space.

The existence time is determined by analyzing the validity of the feature information of the specified in the player image when the storage duration is greater than a first threshold value.

It may be understood that when the identification information of the game player is stored in the buffer storage space, and after the storage duration of the identification information of the game player in the buffer storage space is acquired, it is also necessary to further analyze the validity of the feature information of the specified part in the player image, and the existence time is determined when it is determined that the feature information of the specified part in the player image is in a valid state. The feature information of the specified part in the player image is in the valid state, which may indicate that the game player continuously remains in the game area, so the actual game state of the game player in the game place more fit the actual game situation of the game player by means of the existence time determined by the above-mentioned steps.

In some embodiments, the method may further include the following operation.

When the storage duration is greater than a second threshold value, at least one of the identification information of the game player, the feature information of the game player, or the current position information of the game player is sent to a management device of the game place.

It may be understood that when the storage duration of the identification information of the game player in the buffer storage space is greater than the second threshold value, it may be considered that related information of the game player is comprehensive. At this time, at least one of the feature information of the game player or the current position information of the game player is sent to the management device of the game place, which is beneficial to making the management device of the game place comprehensively know the relevant information of the game player.

In some embodiments, the operation that the residence time of the game player in the game area is determined includes the following operation.

When the duration that the player image does not carry the feature information of the game player is greater than a third threshold value, the residence time of the game player in the game area is determined on the basis of the identification information of the game player and the existence time of the feature information of the game player in the player image.

It may be understood that the residence time of the game player in the game area is determined on the basis of the identification information of the game player and the existence time of the feature information of the game player in the player image when the duration that the player image does not carry the feature information of the game player is greater than the third threshold value. During a tabletop game, the feature information of the game player may temporarily disappear from few player images when the game player executes part operations. For example, during the tabletop game, the game player puts his hand at a lower end of the game area, in this case, if the image collection range of the image collection apparatus is limited, it may directly lead to the fact that the player image does not carry the feature information of the game player. At this time, if a small number of frames of player images do not carry the feature information of the game player, it may lead to false determination of the residence time of the game player in the game area. Therefore, the probability of false determination of the residence time of the game player in the game area can be reduced through the above-mentioned steps.

In some embodiments, the method may further include the following operations.

The player image is analyzed to determine an associated part in the player image. The associated part includes at least one other part, associated with the specified part, of the game player.

The feature information of the associated part in the player image is analyzed to determine the existence time.

It may be understood that the feature information of the associated part may still be analyzed to determine the existence time when the player image does not carry the feature information of the specified part, so that the determination of the existence time is more flexible and robust.

In some embodiments, the operation that the feature information of the associated part in the player image is analyzed to determine the existence time may include the following operation.

The feature information of the associated part is analyzed to determine the existence time when the player image does not carry the feature information of the specified part.

It may be understood that the associated part in the player image may also be determined and then the feature information of the associated part in the player image is analyzed to determine the existence time when the player image does not carry the feature information of the specified part. Some special operations may be executed by the game player during the tabletop game, so that the player image collected by the image collection apparatus cannot carry the feature information of the specified part. Therefore, the above-mentioned method provided by the embodiments of the disclosure can reduce the probability of an existence time statistical error caused by that fact that the player image does not carry the feature information of the specified part.

In some embodiments, the method may further include the following operation.

The residence time of the game player in the game area is sent to the management device of the game place. The game place is provided with at least one game area.

It may be understood that the unified management of the residence time of the game player in each game area may be realized by sending the residence time of the game player in the game area to the management device of the game place, so as to provide comprehensive data support for the determination of a trajectory of the game player in the game place.

In some embodiments, the method may further include that: the trajectory of the game player in the game place is determined according to the residence time of the game player in each game area and the timestamp of the player image.

It may be seen that the trajectory of the game player in the game place may be obtained through the embodiments of the disclosure, so as to realize the tracking of the trajectory of the game player.

In some embodiments, the specified part includes at least one of a face, a hand, or a fingerprint.

It may be understood that any local feature can objectively and uniquely represent the feature information of the game player, so as to provide an objective basis for the accuracy of identification information.

The embodiments of the disclosure further provide a residence time determination apparatus. The apparatus may include an acquisition module, a first determination module, and a second determination module.

The acquisition module is configured to acquire a player image that is collected by an image collection apparatus and includes a specified part of a game player. The image collection apparatus is deployed in a game area.

The first determination module is configured to determine identification information of the game player on the basis of feature information of the specified part in the player image.

The second determination module is configured to determine the residence time of the game player in the game area on the basis of the identification information of the game player and the existence time of the feature information of the game player in the player image.

In some embodiments, the first determination module is configured to determine the identification information of the game player on the basis of feature information of specified part in the player image, which includes the following operations.

An identification information set including the identification information of at least one game player is acquired. The identification information set includes the feature information of the specified part of the at least one game player, and the identification information corresponding to the feature information of the specified part of the at least one game player.

The identification information is determined on basis of the identification information set and the feature information of the specified part.

In some embodiments, the acquisition module is configured to acquire an identification information set including the identification information of at least one game player, which includes the following operations.

The identification information set is acquired from an edge computing device when the edge computing device stores the identification information set; and/or

the identification information set is acquired from a cloud device when edge computing device does not store the identification information set.

In some embodiments, the second determination module is configured to determine the residence time of the game player in the game area on the basis of the identification information of the game player and the existence time of the feature information of the game player, which includes the following operation.

The residence time of the game player, corresponding to the identification information, in the game area is determined on the basis of the existence time when the identification information of the game player is stored in a buffer storage space corresponding to the game area.

In some embodiments, the first determination module is configured to analyze the player image, and store the identification information of the game player in the buffer storage space corresponding to the game area when it is determined that the game player executes a specified operation.

In some embodiments, the acquisition module is configured to acquire the storage duration of the identification information of the game player in the buffer storage space when the identification information of the game player is stored in the buffer storage space.

The second determination module is configured to analyze the validity of the feature information of the specified part in the player image to determine the existence time when the storage duration is greater than a first threshold value.

In some embodiments, the apparatus further includes a sending module, which is configured to send at least one of the identification information of the game player, the feature information of the game player, or the current position information of the game player to a management device of the game place when the storage duration is greater than a second threshold value.

In some embodiments, the second determination module is configured to determine the residence time of the game player in the game area, which includes the following operation.

The residence time of the game player in the game area is determined on the basis of the identification information of the game player and the existence time of the feature information of the game player in the player image when the duration that the player image does not carry the feature information of the game player is greater than a third threshold value.

In some embodiments, the second determination module is configured to analyze the player image to determine an associated part in the player image. The associated part includes at least one other part, associated with specified part, of the game player.

The second determination module is further configured to analyze the feature information of the associated part in the player image to determine the existence time.

In some embodiments, the second determination module is configured to analyze the feature information of the associated part in the player image to determine the existence time, which includes the following operation.

The feature information of the associated part is analyzed to determine the existence time when the player image does not carry the feature information of the specified part.

In some embodiments, the second determination module is further configured to determine the trajectory of the game player in the game place according to the residence time of the game player in each game area and the timestamp of the player image.

In some embodiments, the sending module is configured to send the residence time of the game player in the game area to the management device of the game place. The game place is provided with at least one the game areas.

In some embodiments, the specified part includes at least one of a face, a hand, or a fingerprint.

The embodiments of the disclosure further provide an edge computing device. The edge computing device is configured to acquire a player image that is collected by an image collection apparatus and includes a specified part of a game player. The player image is continuously collected by the image collection apparatus.

The edge computing device includes a processor and a memory.

The memory stores a computer executable instruction.

The residence time determination method according to any of the foregoing embodiments can be implemented when the processor executes the computer executable instruction stored in the memory.

The embodiments of the disclosure further provide a computer storage medium. The computer storage medium stores a computer executable instruction. The residence time determination method according to any of the foregoing embodiments can be implemented after the computer executable instruction is executed.

According to the residence time determination method and apparatus, the edge computing device, and the storage medium provided by the embodiments of the disclosure, the player image that is collected by the image collection apparatus and includes the specified part of the game player is acquired, the image collection apparatus is deployed in the game area, the identification information of the game player is determined on the basis of feature information of the specified part in the player image, and the residence time of the game player in the game area is determined on the basis of the identification information of the game player and the existence time of the feature information of the game player in the player image.

It can be seen that the identification information of the game player may be determined by using the player image that is continuously collected by the image collection apparatus, and the residence time of the game player in the game area may also be determined according to the existence time of the feature information of the game player in the player image and the identification information of the player, so that the embodiments of the disclosure may determine the residence time of the game player in the game area accurately, thereby providing data support for trajectory tracking of the game player in the game place.

It is to be understood that the above general description and the following detailed description are only intended to be illustrative and not restrictive, instead of limiting the disclosure.

### BRIEF DESCRIPTION OF THE DRAWINGS

FIG. 1 is a flowchart of a first residence time determination method provided by embodiments of the disclosure.

FIG. 2 is a flowchart of a second residence time determination method provided by the embodiments of the disclosure.

FIG. 3 is an architecture diagram of the residence time determination method for a game area provided by the embodiments of the disclosure.

FIG. 4 is a schematic structural diagram of a residence time determination apparatus provided by the embodiments of the disclosure.

FIG. 5 is a structural diagram of an edge computing device provided by the embodiments of the disclosure.

### DETAILED DESCRIPTION

The disclosure is further described below in detail with reference to accompanying drawings and embodiments. It is to be understood that the embodiments provided herein are only adopted to explain the disclosure and not intended to limit the disclosure. In addition, the embodiments provided below are not all embodiments implementing the disclosure but part of embodiments implementing the disclosure, and the embodiments of the disclosure may be freely combined for implementation without conflicts.

It is to be noted that, in the embodiments of the disclosure, terms “include” and “contain” or any other variant thereof is intended to cover nonexclusive inclusions herein, so that method or device including a series of elements not only includes those clearly recorded elements but also includes other elements which are not clearly listed or further includes intrinsic elements for implementing the method or the device. Under the condition of no more limitations, an element defined by a statement “including a/an . . . ” does not exclude existence of another related element in a method or device including the element (for example, step in the method or a unit in the device, the unit may be, for example, part of a circuit, part of a processor and part of a program or software).

For example, an image processing method provided by the embodiments of the disclosure includes a series of steps, but the image processing method provided by the embodiments of the disclosure is not limited to the recorded steps. Similarly, an image processing apparatus provided by the embodiments of the disclosure includes a series of modules, but the apparatus provided by the embodiments of the disclosure is not limited to include the clearly recorded modules, and may further include a module required to be arranged when related information is acquired or processing is performed on the basis of information.

The term “and/or” in this specification describes only an association relationship for describing associated objects and represents that three relationships may exist. For example, A and/or B may represent the following three cases: only A exists, both A and B exist, and only B exists. In addition, term “at least one” in the disclosure represents any one of multiple or any combination of at least two of multiple. For example, including at least one of A, B, or C may represent including any one or more elements selected from a set formed by A, B, and C.

The embodiments of the disclosure may be applied to an edge computing device in a game scene, and may be operated together with numerous other universal or dedicated computing system environments or configurations. Here, the edge computing device may be a thin client, a thick client, a handheld or laptop device, a microprocessor-based system, a set-top box, a programmable consumer electronic product, a network personal computer, a minicomputer system, etc.

The edge computing device may execute an instruction through a program module. Generally, the program module may include a routine, a program, a target program, a component, a logic, a data structure and the like, and they execute specific tasks or implement specific abstract data types. The computer system/server may be implemented in a distributed cloud computing environment, and in the distributed cloud computing environment, tasks are executed by a remote processing device connected through a communication network. In the distributed cloud computing environments, the program modules can be located in both local or remote computer storage media including storage devices.

In actual application, an image collection apparatus is generally arranged at an entrance/exit of a game place. Whether a game player enters the game place or not may be roughly determined through images or videos collected by these image collection apparatuses. However, a specific game item that the game player participates in the game place, the residence time in the game item, etc. cannot be determined accurately. For example, in some special scenarios, such as during the high incidence of epidemics, because the specific participation time of a game player in a game item in a game place cannot be determined accurately, so the contact information between the game player and other players in the game place cannot be tracked, and the infection of epidemics cannot be prevented in the game place.

In some embodiments of the disclosure, a residence time determination method is provided, which can be applied to a game scenario.

The following exemplarily describes an application scenario of the embodiments of the disclosure.

In a game scenario, states of various games may be monitored through a computer vision processing technology.

In some embodiments, a game in the game scenario may be a poker game or other games in a game platform, which is not limited in the embodiments of the disclosure.

In the embodiments of the disclosure, computer vision is a science that studies how to make a machine “see”, which refers to identifying, tracking, and measuring a target by using a camera and computer instead of human eyes, and further performing image processing. During a game, the state of a game area may be detected by using at least three cameras so as to perform further analysis. The game area may be a physical tabletop platform or other physical platforms.

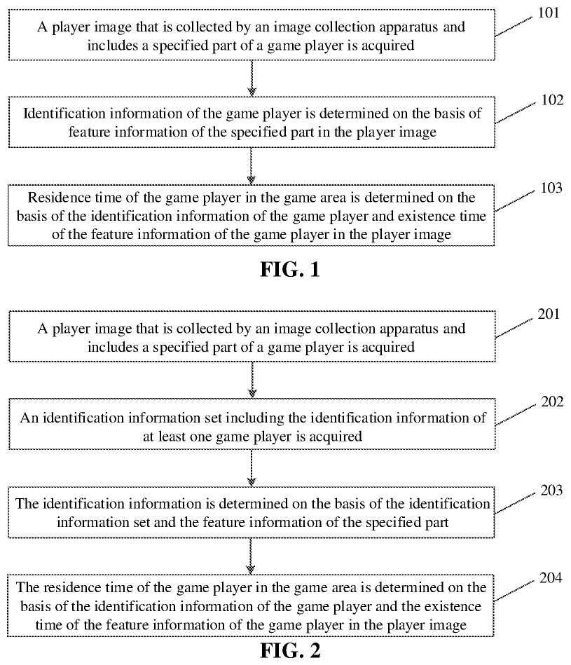

FIG. 1 is a flowchart of a first residence time determination method provided by embodiments of the disclosure. As shown in FIG. 1, a process may include the following operations.

At Step 101, a player image that is collected by an image collection apparatus and includes a specified part of a game player is acquired.

The player image is continuously collected or periodically collected by the image collection apparatus. The image collection apparatus is deployed in a game area. Exemplarily, each game area may include at least one game tabletop.

In the embodiments of the disclosure, the image collection apparatus may be a camera. The number of image collection apparatuses may be at least one. In actual application, the game tabletop may be photographed by using at least one camera, so as to obtain video data or image data, and then obtain a plurality of frames of player images from the video data or the image data.

In some embodiments, the image collection apparatus may be a camera arranged right above the game tabletop, and may also be a camera arranged at any angle of the game tabletop. Correspondingly, the player image may be an image of a game tabletop in vertical view or an image of the game tabletop in other views. Exemplarily, other views may include an angle in the same horizontal direction as the game player, for example, the left side or the right side of the game player.

In the embodiments of the disclosure, the collection operation of the image collection apparatus, for example, may be a video photographing operation. In some embodiments, the collection operation of the image collection apparatus, for example, may be an image collecting operation executed at an image collection frequency. The image collection frequency can include any time interval between 5 seconds and 10 seconds. Exemplarily, the image collection frequency may be adjusted by the image collection apparatus according to environmental information of the game place and/or the game area. The environmental information may include the illumination brightness of the game place and/or the game area, the occlusion condition of the game area in the game place, etc. For example, when the illumination brightness of the game place and/or the game area is weak, the image collection frequency may be set as a high frequency to increase the number of image collection, so as to combat image noise caused by the illumination brightness. Exemplarily, the image collection frequency may also be determined by a management system of the game place according to a working state of the image collection apparatus. For example, when the number of the image collection apparatuses in the working state is small, the image collection frequency may be set as a high frequency. Exemplarily, the image collection frequency may also vary according to different game items. For example, for a game item with many game links and short switching time of each link, the image collection frequency may be set as a high frequency. On the contrary, for a game item with few game links and long switching time of each link, the image collection frequency may be set as a lower frequency.

In the embodiments of the disclosure, the collecting operation of the image collection apparatus may vary along with an operating state of the game place. For example, when the game place starts to operate, the image collection apparatus starts the collecting operation. Exemplarily, the collecting operation of the image collection apparatus may be started after a game tabletop arranged corresponding to the collecting operation of the image collection apparatus is switched to a specified state. The game tabletop is switched to the specified state may include that the game tabletop is switched to a game starting state.

In the embodiments of the disclosure, each player image may also be the image obtained by performing fusion processing on an image of a game area in a vertical view and an image of the game area in other views.

In the embodiments of the disclosure, the number of image collection apparatuses may be at least one.

In the embodiments of the disclosure, the specified part of the game player may be the whole body of the game player. Exemplarily, the specified part of the game player may include at least one part of the game player.

At Step 102, identification information of the game player is determined on the basis of feature information of the specified part in the player image.

In the embodiments of the disclosure, each frame of player image may be processed through the computer vision processing technology after the player image is obtained, so as to obtain an identification result of each frame of the player image. Exemplarily, the identification result may include the feature information of the specified part of the game player.

In the embodiments of the disclosure, the identification information of the game player may include identity identification information of the game player. For example, a game player identification (ID) number, a passport number, a household register number, a temporary residence permit number, a driving license number, a permanent residence permit number, etc. In some embodiments, the identification information of the game player may also include the name, the address, the birthplace, the birth date, etc. of the game player. In some embodiments, the identification information of the game player may also include the occupational state of the game player. In some embodiments, the identification information of the game player may also include the number of money substitutes purchased by the game player after entering the game place.

In the embodiments of the disclosure, the identification information of the game player may also include member information of the game player in the game place. Exemplarily, the above-mentioned member information may include the above-mentioned various types of identification information provided by the game player when registering a member of the game place, and may also include member level information of the game player in the game place.

In the embodiments of the disclosure, a confirmation operation of the identification information may be stopped after the identification information of the game player is determined on the basis of the feature information of the specified part in the kth frame of the player image. Herein, k is an integer greater than or equal to 1.

In the embodiments of the disclosure, the feature information of the specified part may be extracted after computer vision processing is performed on a plurality of frames of player images.

At Step 103, the residence time of the game player in the game area is determined on the basis of the identification information of the game player and the existence time of the feature information of the game player in the player image.

In the embodiments of the disclosure, the existence time of the feature information of the game player in the player image may be the time that the feature information of the game player continues appearing in the player image. Exemplarily, the feature information of the game player continues appearing in the player image may include that the whole body of the game player continues appearing in the player image, or at least one body part of the game player continues appearing in the player image, or a specified part of the game player continues appearing in the player image.

Existence time of the feature information of the game player in the player image may also be the total time that the feature information of the game player appears many times in the player image. Exemplarily, if the game player goes out to eat for 2 hours after playing the game at table A for 1 hour and plays the game at table A for 1 hour after returning, then the existence time of the game player at table A should be 2 hours.

In the embodiments of the disclosure, the residence time of the game player in the game area may include the duration of residence of the game player in the game area or the total time of a plurality of times of residence.

In the embodiments of the disclosure, the identification information of the game player and the number information of the game area may also be organized with the residence time of the game player in the game area together when the residence time of the game player in the game area is determined. Exemplarily, a timestamp of the player image may also be determined, and the start time and end time of the above-mentioned residence time length may be determined according to the timestamp of the player image. Exemplarily, operation information executed in a game process by the game player may also be determined. For example, bodily contact information between any game player and another game player.

In practical applications, Step 101 to Step 103 may be implemented using a processor in an edge computing device. The processor may be at least one of an Application Specific Integrated Circuit (ASIC), a Digital Signal Processor (DSP), a Digital Signal Processing Device (DSPD), a Programmable Logic Device (PLD), a Field-Programmable Gate Array (FPGA), a Central Processing unit (CPU), a controller, a microcontroller, or a microprocessor.

As can be seen from the above, according to the residence time determination method provided by the embodiments of the disclosure, the identification information of the game player can be determined on the basis of the feature information of the specified part of the player image after the edge computing device acquires the player image that is collected by the image collection apparatus and includes the specified part of the game player, and then the residence time of the game player in the game area can be determined on the basis of the identification information of the game player and the existence time of the feature information of the game player in the player image. The residence time of the game player in the game area may include the identification information of the game player, the number information of the game area, and start and end time information of the game player staying in the game area, so that the residence time determination time provided by the embodiments of the disclosure can accurately determine the game item and participation time of the game player in the game place.

Further, the embodiments of the disclosure may be applied not only to a poker game scenario, but also to various scenarios using money substitutes.

FIG. 2 is a flowchart of a second residence time determination method provided by the embodiments of the disclosure. As shown in FIG. 2, the process may include the following operations.

At Step 201, a player image that is collected by an image collection apparatus and includes a specified part of a game player is acquired.

In the embodiments of the disclosure, each game tabletop in the game place is configured with a corresponding image collection apparatus. Exemplarily, the working state of the image collection apparatus may be controlled by a management device of the game place in a unified manner, and may also be controlled by a management device of a corresponding game tabletop.

At Step 202, an identification information set including the identification information of at least one game player is acquired.

The identification information set includes the feature information of the specified part of the at least one game player, and the identification information corresponding to the feature information of the specified part of the at least one game player.

In the embodiments of the disclosure, the feature information of the specified part of the at least one game player and the identification information of the game player have one-to-one correspondence. In some embodiments, when the identification information of the game player includes a variety of information, various types of information in the identification information of the game player can be combined together in a form of structure or array.

In the embodiments of the disclosure, the feature information of the specified part of the game player included in the identification information set may be collected by at least one image collection apparatus arranged at an entrance of the game place before the game player enters the game place. The identification information that is included in the identification information set and corresponds to the feature information of the specified part of the game player may be input by the game player when the game players enters the game place. In some embodiments, the identification information input by the game player may be manually input by the game player. In this case, the identification information input by the game player may also be further verified by management personnel of the game place or a management device of the game place according to a certificate that is provided by the game player and can confirm the identity information. In some embodiments, the identification information input by the game player may be determined in a manner of performing image collection, scanning, etc. on the certificate that is provided by the game player and can confirm the identity information by the management device of the game place.

In some embodiments, the operation that an identification information set including the identification information of at least one game player is acquired includes the following operations.

The identification information set is acquired from an edge computing device when the edge computing device stores the identification information set; and/or the identification information set is acquired from a cloud device when the edge computing device does not store the identification information set.

In the embodiments of the disclosure, the identification information set may be stored in a memory of the edge computing device. Exemplarily, the identification information set stored in the memory of the edge computing device may be determined according to the identification information input when each game player enters the game place and the feature information of the specified part collected by the image collection apparatus when the game player enters the game place. In some embodiments, the identification information set stored in the edge computing device may be acquired by the edge computing device from a cloud device. Exemplarily, the operation that the identification information set is acquired by the edge computing device from the cloud device may be executed periodically.

In the embodiments of the disclosure, the edge computing device stores the identification information set, which may include that the feature information of the specified part collected by the image collection apparatus when the game player enters the game place and the identification information belong to valid information, or the feature information of the specified part and the identification information are not damaged in a processing process. Correspondingly, the edge computing device does not store the identification information set, which may include that the identification information set stored in the memory of the edge computing device is valid information, or the version of the identification information set stored in the memory of the edge computing device is too old to meet the requirement on determining the current identification information.

In the embodiments of the disclosure, the cloud device may be shared by at least one game place. The identification information set stored in the cloud device belongs to data with high privacy, so the cloud device may set corresponding account information for the game place. When the edge computing device needs to acquire the identification information set, a data acquisition request carrying the account information may be sent to the cloud device for the cloud device to verify the validity of the data acquisition request of the edge computing device, so that guarantee is provided for data security of the identification information set.

In the embodiments of the disclosure, the identification information set may be stored in the edge computing device, so as to realize quick determination of the identification information. The identification information set stored in the cloud device may be sent to the edge computing device according to the requirement on identification information determination of the edge computing device, so as to realize secure backup and stable update of data of the identification information set, thereby providing guarantee for the determination of the identification information.

Step 203, the identification information is determined on basis of the identification information set and the feature information of the specified part.

In the embodiments of the disclosure, the identification information is determined on the basis of a matching relationship between the feature information of the specified part included in the identification information set and the feature information of the specified part collected by the image collection apparatus.

In the embodiments of the disclosure, the identification information is not determined according to a single factor of the feature information of the specified part, but is determined according to two factors of the feature information of the specified part in the player image and the identification information set, so that the finally determined identification information is more accurate.

At Step 204, the residence time of the game player in the game area is determined on the basis of the identification information of the game player and the existence time of the feature information of the game player in the player image.

In the embodiments of the disclosure, the operation that the residence time of the game player on a game tabletop is determined on the basis of the identification information of the game player and the existence time of the feature information of the game player in the player image may include the following operation.

The residence time of the game player, corresponding to the identification information, on the game tabletop is determined on the basis of the residence time when the identification information of the game player is stored in a buffer storage space corresponding to the game tabletop.

In the embodiments of the disclosure, a corresponding buffer storage space is set for each game tabletop in the game place. Exemplarily, communication connection may be established between the buffer storage space and the processor and the memory of the edge computing device.

In the embodiments of the disclosure, the buffer storage space may be configured to store a game state of any game of the game tabletop. Exemplarily, the game state may include a progress of a game, an interaction process among game players participating in the game, etc. In some embodiments, the buffer storage space may be configured to store the identification information of the game player on the game tabletop, and may also be configured to store first time when the game player participates in the tabletop game. In some embodiments, the buffer storage space may also store a second time when the game player leaves the game tabletop or ends the tabletop game. Exemplarily, the residence time of the game player on the game tabletop may be calculated according to the first time and the second time.

In the embodiments of the disclosure, the buffer storage space may have the characteristics of high access speed, capacity of processing concurrent data access operations, etc. Exemplarily, the buffer storage space may include redis.

In some embodiments, the buffer storage space may also store a player image, correspondingly, the buffer storage space may also store an identification information set.

It may be understood that the residence time of the game player on the game tabletop may be determined quickly and accurately by reading the data of the buffer storage space when the identification information of the game player is stored in the buffer storage space corresponding to the game tabletop.

The residence time determination method provided by the embodiments of the disclosure may further include the following operations.

A player image is analyzed, and the identification information of the game player is stored in the buffer storage space corresponding to the game tabletop when it is determined that the game player executes a specified operation.

Correspondingly, the player image is analyzed, and the identification information of the game player may not be stored in the buffer storage space corresponding to game tabletop when it is determined that the game player do not execute a specified operation.

In the embodiments of the disclosure, the specified operation executed by the game player may include a gesture of the game player. For example, a sliding operation of the game player in a specified area on the game tabletop. The specified operation executed by the game player may be determined according to position change information of a specified part in adjacent of a plurality of frames of player images. In some embodiments, the specified operation executed by the game player may include a behavior that the game player participates in the tabletop game. For example, a behavior that the game player places a money substitute in a specified area of the game tabletop. The behavior that the game player places the money substitute in the specified area of the game tabletop may be determined by analyzing the feature information corresponding to the specified area in the player image.

In the embodiments of the disclosure, the operation that identification information of the game player is stored in the buffer storage space corresponding to the game tabletop when it is determined that the game player executes a specified operation may include that: the specified operation executed by the game player is analyzed when it is determined that the specified operation of the game player indicates that the game player wants to join the tabletop game of the game tabletop, the identification information of the game player is stored in the buffer storage space corresponding to the game tabletop. In some embodiments, the specified operation executed by the game player is analyzed, and the identification information of the game player is stored in the buffer storage space corresponding to the game tabletop when it is determined that the specified operation of the game player indicates that the distance between the game player and any player who is participating in the tabletop game is less than a first distance threshold value, or the distance between the game player and the game tabletop is less than a second distance threshold value.

In the embodiments of the disclosure, the identification information of the game player is stored in the buffer storage space corresponding to the game tabletop only when it is determined that the game player executes the specified operation, so as to reduce the number of times of storing the identification information of the game player in the buffer storage space corresponding to the game tabletop, and also reduce the amount of redundant data in the buffer storage space corresponding to the game tabletop.

In the embodiments of the disclosure, the residence time determination method provided by the embodiments of the disclosure may also include the following operations.

The storage duration of the identification information of the game player in the buffer storage space is acquired when the identification information of the game player is stored in the buffer storage space. The validity of the feature information of a specified part in the player image is analyzed to determine existence time when the storage duration is greater than a first threshold value.

Correspondingly, the storage duration of the identification information in the buffer storage space cannot be acquired when the identification information of the game player is not stored in the buffer storage space.

Correspondingly, if the acquired storage duration is less than or equal to the first threshold value when the identification information of the game player is stored in the buffer storage space, the validity of the feature information of the specified part of the game player may not be analyzed until the storage duration is greater than the first threshold value.

In the embodiments of the disclosure, timestamp information corresponding to the identification information of the game player may also be set in the buffer storage space when the identification information of the game player is stored in the buffer storage space, so that the timestamp information may be analyzed to determine the storage duration of the identification information of the game player in the buffer storage space. In some embodiments, in the buffer storage space, the above-mentioned timestamp information may be set as additional information of the identification information of the game player. Exemplarily, when the identification information of any game player is obtained, the corresponding timestamp information may be obtained on the basis of the identification information of the game player, i.e., the storage duration of the identification information of the game player in the buffer storage space.

In the embodiments of the disclosure, the first threshold value may be determined by the edge computing device according to actual situations. Exemplarily, the first threshold values in the buffer storage spaces corresponding to different game tabletops may be different. The edge computing device may adjust the first threshold value according to the number of the game players on the game tabletop.

In the embodiments of the disclosure, the validity of the feature information of the specified part in a game player image may include the clarity, contrast, and brightness of the feature information of the specified part in the game player image, the correlation strength among the feature information of the specified parts of a plurality of game players, etc. In some embodiments, the edge computing device may set a corresponding threshold value for feature information of each dimension, and then the validity of the feature information of the corresponding dimension is determined by determining the magnitude relationship between the feature information of the specified part and the corresponding threshold value. For example, a clarity threshold value may be set. If the clarity of the feature information of the specified part is less than the clarity threshold value, then it may be determined that the validity of the feature information of the dimension of the clarity is weak. In some embodiments, it may be determined that the validity of the feature information of the specified part is weak or the feature information of the specified part is in an invalid state when the number of valid dimensions of the feature information of the specified part is small.

In the embodiments of the disclosure, the validity of the feature information of the specified part in the game player image may include the validity of the feature information of the specified part in the game player image collected within a specified time length. Exemplarily, the specified time length may be set by the edge computing device according to actual situations. For example, the edge computing device may set a specific numerical value of the specified time length according to at least one of the number of the game tabletop, the type of the tabletop game, the number of the game players on the game tabletop, etc.

In the embodiments of the disclosure, the existence time may be determined according to the timestamp when the validity of the feature information of the specified part in the player image is strong. On the contrary, when the validity of the feature information of the specified part in the player image is weak, the feature information of the specified part in the player image may be continuously analyzed until the validity of the feature information of the specified part carried in the player image within the specified time length is strong.

In the embodiments of the disclosure, when the identification information of the game player is stored in the buffer storage space, and after the storage duration of the identification information of the game player in the buffer storage space is acquired, it is also necessary to further analyze the validity of the feature information of the specified part in the player image, and the existence time is determined only when it is determined that the feature information of the specified part in the player image is in a valid state. The feature information of the specified part in the player image is in the valid state, which may indicate that the game player is continuously located at the position where the game tabletop is located, then the actual entertainment state of the game player in the game place may be determined more accurately by the existence time determined by the above-mentioned steps.

In the embodiments of the disclosure, when the storage duration is greater than a second threshold value, at least one of the identification information of the game player, the feature information of the game player, or the current position information of the game player may be sent to a management device of the game place.

Here, the second threshold value may be set according to an actual scenario requirement. For example, the second threshold value is 30 seconds, 1 minute, etc.

It may be understood that when the storage duration of the identification information of the game player in the buffer storage space is greater than the second threshold value, it may be considered that related information of the game player is comprehensive. At this time, at least one of the feature information of the game player or the current position information of the game player is sent to the management device of the game place, which is beneficial to making the management device of the game place comprehensively know the relevant information of the game player.

In the embodiments of the disclosure, the operation that the residence time of the game player in game tabletop is determined may include the following operation.

The residence time of the game player in the game tabletop is determined on the basis of the identification information of the game player and the existence time of the feature information of the game player in the player image when the duration that the player image does not carry the feature information of the game player is greater than a third threshold value.

Correspondingly, the duration that the player image does not carry the feature information of the game player may be counted continuously when the duration that the player image does not carry the feature information is less than or equal to the third threshold value.

In the embodiments of the disclosure, the player image continuously carries the feature information of the player image, which may include that each frame of the player image carries the feature information of the game player, and may also include that the number of player images greater than or equal to a frame number threshold of the specified number of player images carry the feature information of the game player. Correspondingly, the player image does not carry the feature information of the player image, which may include that a specified number of the player images do not carry the feature information of the game player, and may also include that the number of player images greater than a frame number threshold of a specified number of player images do not carry the feature information of the game player. Exemplarily, for example, in N frames of player images, M frames of player images do not carry the feature information of the game player, if M is greater than the frame threshold value, then it may be determined that the N frames of player images do not continuously carry the feature information of the game player. If M is less than or equal to the frame threshold value, then it may be determined that the N frames of player images continuously carry the feature information of the game player. Herein, M is an integer greater than or equal to 0, and N is an integer greater than M.

In the embodiments of the disclosure, the edge computing device may count the number of the player images carrying the feature information of the game player. Exemplarily, the player image may carry the timestamp information that the image collection apparatus collects the player image. The edge computing device may determine the existence time of the feature information of the game player in the player image according to the timestamp information of the player image and the number of the player images carrying the feature information of the game player.

In the embodiments of the disclosure, when it is determined that the duration that the player image does not carry the feature information of the game player is greater than a third threshold value, the timestamp information of the player image that does not carry the feature information of the game player is analyzed to determine the disappearance time of the feature information of the game player in the player image. For example, the second threshold value may be 3 minutes. In the embodiments of the disclosure, the disappearance time of the feature information of the game player in the player image may be the timestamp information corresponding to a first frame of player image of a plurality of frames of player images that do not carry the feature information of the game player, and may also be the timestamp information corresponding to the player image, located at a middle position, of the M frames of player images that do not carry the feature information of the game player.

In the embodiments of the disclosure, the residence time of the game player on a game tabletop may be determined when the appearance time of the feature information of the game player, the existence time of the feature information of the game player, and the disappearance time of the feature information of the game player are determined.

In the embodiments of the disclosure, the residence time of the game player on a game tabletop is determined on the basis of the identification information of the game player and the existence time of the feature information of the game player in the player image only when the duration that the player image does not carry the feature information of the game player is greater than a third threshold value. During a tabletop game, the feature information of the game player may temporarily disappear from few player images when the game player executes part operations. For example, during the tabletop game, the game player puts his hand at a lower end of the game tabletop, in this case, it may lead to the fact that the player image does not carry the feature information of the game player. At this time, if a small number of frames of player images do not carry the feature information of the game player, it may lead to false determination of the residence time of the game player on the game tabletop. Therefore, the probability of false determination of the residence time of the game player on the game tabletop can be reduced through the above-mentioned steps.

In the embodiments of the disclosure, the specified part may include at least one of a face, a hand, or a fingerprint.

In the embodiments of the disclosure, a five-sense-organ feature, a key point feature, etc. of the game player may be determined by analyzing the facial feature of the game player in the player image. The length of fingers, the size of palms, the density of palm prints, etc. of the game player may be determined by analyzing the hand feature of the game player in the player image. The basic shape of the fingerprint of the game player may be determined by analyzing the fingerprint of the game player in the game image. Any local feature above may objectively and uniquely represent the feature information of the game player, so as to provide an objective basis for the accuracy of identification information.

The residence time determination method provided by the embodiments of the disclosure may further include the following operations.

The player image is analyzed to determine the associated part in the player image. The feature information of the associated part in the player image is analyzed to determine the existence time.

The associated part includes at least one other part, associated with the specified part, of the game player.

In the embodiments of the disclosure, the associated part may include at least one other part that is directly associated with the specified part of the game player. For example, when the specified part is a hand, the associated part may include an upper arm. When the specified part is a fingerprint, the associated part may include fingers, and the whole hand. When the specified part is a face, the associated part may include a neck, a neck and a shoulder, etc. In some embodiments, the associated part may include at least one other part that is indirectly associated with the specified part of the game player. For example, when the specified part is a hand, the associated part may include a shoulder and a neck.

In the embodiments of the disclosure, the associated part may include any part of the game player included in the player image. Exemplarily, the feature information of the specified part in a plurality of frames of player images are analyzed, and pixel expansion is performed to the periphery in the player image by taking the feature information of the specified part as a pixel center. Body parts of the game player corresponding to the feature information included in a pixel expansion area may all be associated parts. Exemplarily, the number of the expanded pixels when the pixel expansion is performed to the periphery in the player image by taking the feature information of the specified part as a pixel center may be adjusted flexibly according to the information, such as the resolution of the player image.

In the embodiments of the disclosure, association analysis may be performed on the feature information of the associated part in the player image and the feature information of the specified part, and the existence time is determined according to a result of the association analysis. Exemplarily, if the relative position relationship between the specified part and the associated part included in the result of the association analysis indicates that the distance between at least one of the specified part or the associated part and the game tabletop is less than a third distance threshold value, the existence time may be counted continuously. On the contrary, the existence time is stopped counting.

In the embodiments of the disclosure, the existence time may be determined by analyzing the feature information of the associated part in the player image when the player image does not carry the feature information of the specified part. Exemplarily, the feature information of the associated part in the player image may be analyzed by using an analysis method for the feature information of the specified part described in the foregoing embodiments, which is not described in detail herein. In such a manner, the feature information of the associated part may still be analyzed to determine the existence time when the player image does not carry the feature information of the specified part, so that the determination of the existence time is more flexible and robust.

In embodiments of the disclosure, the operation that the feature information of the associated part in the player image is analyzed to determine the existence time may include the following operation.

The feature information of the associated part is analyzed to determine the existence time when the player image does not carry the feature information of the specified part.

In the embodiments of the disclosure, the associated part in the player image may also be determined and then the feature information of the associated part in the player image is analyzed to determine the existence time when the player image does not carry the feature information of the specified part. Some special operations may be executed by the game player during the tabletop game, so that the player image collected by the image collection apparatus cannot carry the feature information of the specified part. Therefore, the above-mentioned method provided by the embodiments of the disclosure can reduce the probability of an existence time statistical error caused by that fact that the player image does not carry the feature information of the specified part.

The residence time determination method provided by the embodiments of the disclosure may further include the following operations.

The residence time of a game player on a game tabletop is sent to a management device of a game place.

The game place is provided with at least one game tabletop.

In the embodiments of the disclosure, the buffer storage space corresponding to the game tabletop stores the residence time of the game player on the game tabletop in real time. After it is determined that the game player leaves the game tabletop, a data processing apparatus in the buffer storage space may send the residence time of the game player on the game tabletop to the management device of the game place. Exemplarily, the buffer storage space may also store the game state of the game player on the game tabletop, for example, the type of the tabletop game that the game player participates in the game tabletop, body actions of the game player in the tabletop game, etc. In some embodiments, communication connection may be established between the management device of the game place and the buffer storage space corresponding to each game tabletop.

In the embodiments of the disclosure, unified management of the residence time of the game player in each game tabletop may be realized by sending the residence time of the game player in the game tabletop to the management device of the game place, so as to provide comprehensive data support for the determination of a trajectory of the game player in the game place.

In the embodiments of the disclosure, the trajectory of the game player in the game place may also be determined according to the residence time of the game player on each game tabletop and the timestamp of the player image.

It can be seen that the trajectory of the game player in the game place may be obtained through the embodiments of the disclosure, so as to realize the tracking of the trajectory of the game player.

The following is an exemplary description of an embodiment of the disclosure in combination with an application scenario. In the application scenario, the image collection apparatus may include at least one camera arranged on the periphery of the game tabletop.

The game in a game scenario may be a poker game or other types of games.

In the game scenario, a plurality of frames of player images on the periphery of the game tabletop may be collected by the camera, and then the plurality of collected player images are sent to an edge computing device in a game place. In the edge computing device, each frame of player image of the plurality of frames of player images is detected and identified to obtain feature information of the specified part of the player image.

The edge computing device determines identification information of the game player according to the feature information of the specified part in the player image. The edge computing device may also determine the residence time of the game player on the game tabletop on the basis of the identification information of the game player and the existence time of the feature information of the game player in the player image.

In some embodiments, the identification information of the game player may be determined according to a matching relationship between the feature information of the specified part in the game player and the feature information of the specified part included in an identification information set. Exemplarily, the identification information set may be stored in a memory of an edge computing device. If the memory of the edge computing device does not store the identification information set, or the memory of the edge computing device stores the identification information set but the identification information set does not store feature information of a specified part of a current game player, then the identification information set may be acquired from a cloud device, and then identification information of the game player may be determined on the basis of the identification information set and the feature information of the specified part of a player image.

In some embodiments, the residence time of a game player on a game tabletop may be determined according to the storage duration of the identification information of the game player in the buffer storage space corresponding to the game tabletop, the existence time of the feature information of the specified part of the game player in the player image, a first threshold value, a second threshold value, etc. A specific implementation manner is described as the foregoing embodiments.

In some scenarios, an edge computing device of a game place may accurately grasp the residence time of a game player on at least one game tabletop in real time by a residence time determination method provided by the embodiments of the disclosure, so as to accurately acquire the trajectory information of the game player in the game place.

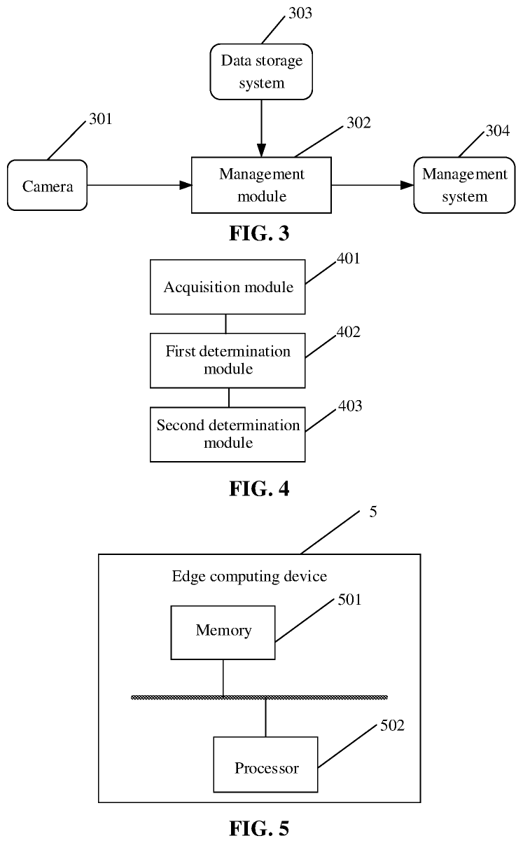

FIG. 3 is an architecture diagram of the residence time determination method for a game area provided by the embodiments of the disclosure.

In FIG. 3, there may be a plurality of cameras 301 arranged on the periphery of the game tabletop. A buffer storage space corresponding to the game tabletop and a management apparatus of the game tabletop may be arranged in a management module 302. The management module 302 may acquire an identification information set from a data storage system 303 after obtaining a player image collected by the camera 301, and determine the identification information of the game player according to the identification information set and the feature information of an execution part of the player image.

In FIG. 3, the camera 301 may collect the player image at a time interval of 5 seconds to 10 seconds, and send the player image to the management module 302 for the management module 302 to analyze the residence time of the game player on the game tabletop. The management module 302 may also analyze the player image to acquire a game state of the game player on the game tabletop, for example, the game player participates in the game or leaves the game tabletop, and the time when the game player participates in the game or leaves the game tabletop. The management module 302 may further send at least one type of the above-mentioned information to the management system 304 when it is determined that the game player leaves the game tabletop. Exemplarily, the management system 304 may be a Graphical Table Terminal (GTT), and the data storage system 303 may be 1B 1CL.

In the embodiments of the disclosure, the management module 302, the data storage system 303, and the management system 304 may be arranged at an Artificial Intelligence Node (AI Node) of the edge computing device. The camera 301 may be an additional device of the AI Node, and provides a player image for the AI Node. The AI Node may acquire an identification information set from the cloud device, so that the AI Node determines the identification information of the game player in real time and further determine the residence time of the game player on the game tabletop, so as to realize accurate tracking of a game trajectory of the game player in the game place under the coordination of the edge computing device and the cloud device.

In some scenarios, for example, emergencies of the outbreak of epidemic infectious diseases and safety events, the residence time determination method provided by the embodiments of the disclosure can quickly determine entertainment trajectory information of each game player in the game place, so as to provide powerful guarantee for rapid processing of the emergencies.

It can be understood by those skilled in the art that, in the above-mentioned method of the specific implementation manners, the writing sequence of each step does not mean a strict execution sequence and is not intended to form any limitation to the implementation process and a specific execution sequence of each step should be determined by functions and probable internal logic thereof.

The embodiments of the disclosure provide a residence time determination apparatus on the basis of the residence time determination method provided by the foregoing embodiments.

FIG. 4 is a schematic structural diagram of a residence time determination apparatus provided by the embodiments of the disclosure. As shown in FIG. 4, the apparatus may include an acquisition module 401, a first determination module 402, and a second determination module 403.

The acquisition module 401 is configured to acquire a player image that is collected by an image collection apparatus and includes a specified part of a game player. The image collection apparatus is deployed in a game area.

The first determination module 402 is configured to determine identification information of game player on basis of feature information of the specified part in player image.

The second determination module 403 is configured to determine the residence time of the game player in the game area on the basis of the identification information of the game player and the existence time of the feature information of the game player in the player image.

In some embodiments, the first determination module 402 is configured to determine the identification information of the game player on the basis of feature information of specified part in the player image, which includes the following operations.

An identification information set including the identification information of at least one game player is acquired. The identification information set includes the feature information of the specified part of the at least one game player, and the identification information corresponding to the feature information of the specified part of the at least one game player.

The identification information is determined on basis of the identification information set and the feature information of the specified part.

In some embodiments, the acquisition module 401 is configured to acquire an identification information set including the identification information of at least one game player, which includes the following operations.

The identification information set is acquired from an edge computing device when the edge computing device stores the identification information set; and/or the identification information set is acquired from a cloud device when the edge computing device does not store the identification information set.

In some embodiments, the second determination module 403 is configured to determine the residence time of the game player in the game area on the basis of the identification information of the game player and the existence time of the feature information of the game player, which includes the following operation.

The residence time of the game player, corresponding to the identification information, in the game area is determined on the basis of the existence time when the identification information of the game player is stored in a buffer storage space corresponding to the game area.

In some embodiments, the first determination module 402 is configured to analyze the player image, and store the identification information of the game player in the buffer storage space corresponding to the game area when it is determined that the game player executes a specified operation.

In some embodiments, the acquisition module 401 is configured to acquire the storage duration of the identification information of the game player in the buffer storage space when the identification information of the game player is stored in the buffer storage space.

The second determination module 403 is configured to analyze the validity of the feature information of the specified part in the player image to determine the existence time when the storage duration is greater than a first threshold value.

In some embodiments, the apparatus further includes a sending module, which is configured to send at least one of the identification information of the game player, the feature information of the game player, or the current position information of the game player to a management device of the game place when the storage duration is greater than a second threshold value.

In some embodiments, the second determination module 403 is configured to determine the residence time of the game player in the game area, which includes the following operation.

The residence time of the game player in the game area is determined on the basis of the identification information of the game player and the existence time of the feature information of the game player in the player image when the duration that the player image does not carry the feature information of the game player is greater than a third threshold value.

In some embodiments, the second determination module 403 is configured to analyze the game image to determine an associated part in the player image. The associated part includes at least one other part, associated with specified part, of the game player.

The second determination module 403 is further configured to analyze the feature information of the associated part in the player image to determine the existence time.

In some embodiments, the second determination module 403 is configured to analyze the feature information of the associated part in the player image to determine the existence time, which includes the following operation.

The feature information of the associated part is analyzed to determine the existence time when the player image does not carry the feature information of the specified part.

In some embodiments, the second determination module 403 is further configured to determine the trajectory of the game player in the game place according to the residence time of the game player in each game area and the timestamp of the player image.

In some embodiments, the sending module is configured to send the residence time of the game player in the game area to the management device of the game place. The game place is provided with at least one the game areas.

In some embodiments, the specified part includes at least one of a face, a hand, or a fingerprint.

In actual application, all of the acquisition module 401, the first determination module 402, and the second determination module 403 can be implemented by using the processor in the edge computing device. The above processor may be at least one of the ASIC, the DSP, the DSPD, the PLD, the FPGA, the CPU, the controller, the microcontroller, or the microprocessor.

Based on the same technical concept as the foregoing embodiments, the embodiments of the disclosure further provide an edge computing device. The edge computing device is used for acquiring a player image that is collected by an image collection apparatus and includes a specified part of a game player. The player image is continuously collected by the image collection apparatus.

FIG. 5 is a structural diagram of an edge computing device 5 provided by an embodiment of the disclosure. As shown in FIG. 5, the edge computing device 5 may include a memory 501 and a processor 502.

The memory 501 stores a computer executable instruction.

Any residence time determination method in the foregoing embodiments can be implemented when the processor 502 executes the computer executable instruction stored in the memory 501.

In addition, various functional modules in the embodiments may be integrated into one processing unit, or each of the units may exist alone physically, or two or more units are integrated into one unit. The integrated unit may be implemented in a form of hardware, or may be implemented in a form of a software functional module.

When the integrated unit is implemented in the form of software function module and is not sold or used as an independent product, it can be stored in a computer readable storage medium. Based on such an understanding, the embodiments may be implemented in a form of a software product. The software product is stored in a storage medium and includes several instructions for instructing a computer device (which may be a personal computer, a server, a network device, or the like) or a processor (processor) perform all or some of the steps of the methods described in the embodiments. The foregoing storage medium includes: any medium that can store program code, such as a USB flash drive, a removable hard disk, a read-only memory (Read Only Memory, ROM), a random access memory (Random Access Memory, RAM), a magnetic disk, or an optical disc.

Specifically, a computer program instruction corresponding to a residence time determination method in the embodiment can be stored on storage media, such as a compact disc, a hard disc, and a USB flash disc. When the computer program instruction corresponding to the residence time determination method in the storage medium is read or executed by an electronic device, any residence time determination method in the foregoing embodiments is implemented.

The above description of various embodiments tends to emphasize the differences among various embodiments, and their same points or similarities can be referred to each other. For simplicity, it will not be repeated here.

The methods disclosed in various method embodiments provided in the disclosure may be freely combined without conflicts to obtain new method embodiments.

The characteristics disclosed in various product embodiments provided in the disclosure may be freely combined without conflicts to obtain new product embodiments.

The characteristics disclosed in various method or device embodiments provided in the disclosure may be freely combined without conflicts to obtain new method embodiments or device embodiments.

It is to be noted that the above-mentioned computer readable storage medium may be a memory such as an ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the above-mentioned memories, such as a mobile phone, a computer, a tablet device, and a personal digital assistant.

It should be noted that in this specification, the term “comprise”, “include”, or any other variant thereof is intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element.

The sequence numbers of the embodiments of the disclosure are adopted not to represent superiority-inferiority of the embodiments but only for description.

According to the description of the foregoing implementations, a person skilled in the art can clearly understand that the method in the foregoing embodiments may be implemented by software in addition to a necessary universal hardware node or by hardware only. In most cases, the former is merely an implementation. Based on such an understanding, this disclosure essentially or a part thereof that contributes to art technologies may be embodied in a form of a software product. The computer software product is stored in a storage medium (for example, a ROM/RAM, a magnetic disk, or an optical disc), and includes several instructions for instructing a terminal Device (which may be a mobile phone, a computer, a server, an air conditioner, a network device, or the like) to perform the methods described in the embodiments of this disclosure.

The disclosure is described with reference to the flowcharts and/or block diagrams of the method, the device (system), and the computer program product according to the embodiments of this disclosure. It is to be understood that each flow and/or block in the flowcharts and/or the block diagrams and a combination of the flows and/or the blocks in the flowcharts and/or the block diagrams may be implemented by computer program instructions. These computer programs can be provided to a universal computer, a special-purpose computer, an embedded processor, or processors of other programmable data processing devices to produce a machine, so that the instructions executed by the computer or the processors of other programmable data processing devices produce an apparatus for implementing functions specified in one or more flows in the flowcharts and/or one or more blocks in the block diagrams.

These computer program instructions can also be stored in a computer readable memory capable of guiding a computer or other programmable data processing devices to work in a specific way, so that instructions stored in the computer readable memory produce a product including an instruction apparatus that implements functions specified in one or more flows in the flowcharts and/or one or more blocks in the block diagrams.

These computer program instructions can also be loaded to a computer or other programmable data processing devices, so that a series of operating steps are performed on the computer or other programmable data processing devices to produce a computer-implemented process, and therefore instructions executed on the computer or the other programmable data processing devices provide steps for implementing functions specified in one or more flows in the flowcharts and/or one or more blocks in the block diagrams.

The above description only provides some embodiments of the disclosure, and thus does not limit the patent scope of the disclosure. Equivalent structure or equivalent process transformations made by the specification and the contents of the accompanying drawings, or directly or indirectly applied to other related technical fields, are all included in the protection scope of the patent of the disclosure.

What is claimed is:

1. A residence time determination method, comprising:
acquiring a player image that is collected by an image collection apparatus and comprises a specified part of a game player, wherein the image collection apparatus is deployed in a game area;
determining identification information of the game player on the basis of feature information of the specified part in the player image; and
determining residence time of the game player in the game area on the basis of the identification information of the game player and existence time of the feature information of the game player in the player image.

2. The method of claim 1, wherein determining the identification information of the game player on the basis of feature information of the specified part in the player image comprises:
acquiring an identification information set comprising the identification information of at least one game player, wherein the identification information set comprises the feature information of the specified part of the at least one game player, and the identification information corresponding to the feature information of the specified part of the at least one game player; and
determining the identification information on the basis of the identification information set and the feature information of the specified part.

3. The method of claim 2, wherein acquiring an identification information set comprising the identification information of at least one game player comprises:
acquiring the identification information set from an edge computing device when the edge computing device stores the identification information set; and/or
acquiring the identification information set from a cloud device when the edge computing device does not store the identification information set.

4. The method of claim 1, wherein determining the residence time of the game player in the game area on the basis of the identification information of the game player and the existence time of the feature information of the game player comprises:
determining the residence time of the game player, corresponding to the identification information, in the game area on the basis of the existence time in a case where the identification information of the game player is stored in a buffer storage space corresponding to the game area.

5. The method of claim 4, further comprising:
analyzing the player image, and storing the identification information of the game player in the buffer storage space corresponding to the game area in a case where it is determined that the game player executes a specified operation.

6. The method of claim 4, further comprising:
acquiring storage duration of the identification information of the game player in the buffer storage space in the case where the identification information of the game player is stored in the buffer storage space; and
determining the existence time by analyzing the validity of the feature information of the specified part in the player image in a case where the storage duration is greater than a first threshold value.

7. The method of claim 6, further comprising:
sending at least one of the identification information of the game player, the feature information of the game player, or current position information of the game player to a management device of a game place in a case where the storage duration is greater than a second threshold value.

8. The method of claim 1, wherein determining the residence time of the game player in the game area comprises:
determining the residence time of the game player in the game area on the basis of the identification information of the game player and the existence time of the feature information of the game player in the player image in a case where a duration in which the image player does not carry the feature information of the game player is greater than a third threshold value.

9. The method of claim 1, further comprising:
analyzing the player image to determine an associated part in the player image, wherein the associated part comprises at least one other part, associated with the specified part, of the game player; and
analyzing the feature information of the associated part in the player image to determine the existence time.

10. The method of claim 9, wherein analyzing the feature information of the associated part in the player image to determine the existence time comprises:
analyzing the feature information of the associated part to determine the existence time in a case where the player image does not carry the feature information of the specified part.

11. The method of claim 1, further comprising:
sending the residence time of the game player in the game area to a management device of a game place, wherein the game place is provided with at least one the game area.

12. The method of claim 11, further comprising:
determining a trajectory of the game player in the game place according to the residence time of the game player in each game area and a timestamp of the player image.

13. The method of claim 1, wherein the specified part comprises at least one of a face, a hand, or a fingerprint.

14. An edge computing device, configured to acquire a player image that is collected by an image collection apparatus and comprises a specified part of a game player, wherein the image collection apparatus is deployed in a game area;
the edge computing device comprises a processor and a memory;
the memory stores a computer executable instruction; and
the processor is configured to execute the computer executable instruction stored in the memory to:
acquire a player image that is collected by an image collection apparatus and comprises a specified part of a game player, wherein the image collection apparatus is deployed in a game area;
determine identification information of the game player on the basis of feature information of the specified part in the player image; and
determine residence time of the game player in the game area on the basis of the identification information of the game player and existence time of the feature information of the game player in the player image.

15. The edge computing device of claim 14, wherein when determining the identification information of the game player on the basis of feature information of the specified part in the player image, the processor is configured to:
acquire an identification information set comprising the identification information of at least one game player, wherein the identification information set comprises the feature information of the specified part of the at least one game player, and the identification information corresponding to the feature information of the specified part of the at least one game player; and
determine the identification information on the basis of the identification information set and the feature information of the specified part.

16. The edge computing device of claim 14, wherein when determining the residence time of the game player in the game area on the basis of the identification information of the game player and the existence time of the feature information of the game player, the processor is configured to:
determine the residence time of the game player, corresponding to the identification information, in the game area on the basis of the existence time in a case where the identification information of the game player is stored in a buffer storage space corresponding to the game area.

17. The edge computing device of claim 14, wherein when determining the residence time of the game player in the game area, the processor is configured to:
determine the residence time of the game player in the game area on the basis of the identification information of the game player and the existence time of the feature information of the game player in the player image in a case where a duration in which the image player does not carry the feature information of the game player is greater than a third threshold value.

18. The edge computing device of claim 14, wherein the processor is further configured to:
analyze the player image to determine an associated part in the player image, wherein the associated part comprises at least one other part, associated with the specified part, of the game player; and
analyze the feature information of the associated part in the player image to determine the existence time.

19. The edge computing device of claim 18, wherein when analyzing the feature information of the associated part in the player image to determine the existence time, the processor is configured to:
analyze the feature information of the associated part to determine the existence time in a case where the player image does not carry the feature information of the specified part.

20. A nonvolatile computer readable storage medium, storing a computer executable instruction, wherein the computer executable instruction is executed to:
acquire a player image that is collected by an image collection apparatus and comprises a specified part of a game player, wherein the image collection apparatus is deployed in a game area;
determine identification information of the game player on the basis of feature information of the specified part in the player image; and
determine residence time of the game player in the game area on the basis of the identification information of the game player and existence time of the feature information of the game player in the player image.
